(19) United States
(12) Patent Application Publication
(10) Pub. No.: US 2005/0160031 A1
(43) Pub. Date: Jul. 21, 2005

(54) Rules-based transaction billing, reporting and compliance system

(76) Inventor: Robert Hendrickson, Bedminster, NJ (US)

Correspondence Address: KATTEN MUCHIN ROSENMAN LLP, 575 MADISON AVENUE, NEW YORK, NY, 10022-2585, US

(21) Appl. No.: 11/022,572

(22) Filed: Dec. 23, 2004

Related U.S. Application Data
(60) Provisional application No. 60/532,749, filed on Dec. 23, 2003.

(51) Int. Cl. G06F 17/60

(52) U.S. Cl. 705/37

(57) ABSTRACT

An automated rules-based transaction processing system supports transaction reconciliation, billing, reporting and compliance activities for securities transactions. The system collects and interprets information from multiple data sources, corrects incorrect and/or inconsistent data, and creates and formats associated billing invoices and other reports. A concise audit trail is created for compliance reporting and exception handling, and for updating the rules base.

### CROSS-REFERENCE TO RELATED APPLICATION

The present application claims priority under 35 U.S.C.§ 119(e) from U.S. Ser. No. 60/532,749, entitled “Rules-Based Transaction Billing, Reporting and Compliance System,” filed on Dec. 23, 2003. U.S. Ser. No. 60/532,749 was filed by an inventor common to the present application, and is hereby incorporated by reference.

### FIELD OF THE INVENTION

The present invention relates to a system and method for reconciling and processing transactional data produced in multiple forms and by multiple sources, including means for auditing the transactional data for compliance purposes.

### BACKGROUND OF THE INVENTION

Stock and commodity exchanges are engaged in complex transactional processes. For example, at the New York Stock Exchange (NYSE), a member may place an order with a floor clerk, who then interacts with one or more brokers, who may in turn interact with a floor specialist to complete the order. Each involved party typically creates records that at least partially detail the complete transaction.

The number of parties participating in the NYSE is substantial. As of June 2003, there are a total of 336 member firms in the NYSE, owning more than 1366 seats. Each seat is estimated to have a market value of approximately $1.5 M.

On the NYSE trading floor, participants include brokers and specialists. Among brokers, commission brokers work directly for brokerage houses that interface with institutional investors and the public, and independent brokers perform trades on behalf of institutional investors, themselves and/or commission brokers who require assistance.

Specialist firms trade 100 percent of the common stocks that are listed on the NYSE, as well as various index stocks (for example, including the DJIA30, S&P100 and S&P500 index stocks). Specialist firms include, for example, LaBranche & Co., LLC; Spear Leeds & Kellogg Specialists; Fleet Specialist, Inc., Van Der Moolen Specialists USA, Bear Wagner Specialists LLC, Performance Specialist Group, LLC and Susquehanna Specialists, Inc. Other smaller specialist firms trading exchange-traded funds rather than common stocks include Bear Hunter Structured Products LLC, SLK Index Specialists, LLC and Susquehanna Index Specialists, LLC.

It is estimated that approximately 326 different broker and specialist firms own NYSE seats, of which approximately 239 deal with the public and of which 10 are specialist firms. Approximately 923 brokers operate on the trading floor, and approximately 443 specialists operate on the trading floor. The specialists are stationed at 18 different “trading posts”, at which both specialists and clerks take positions in stock and execute orders placed by the brokers. There are approximately 1500 trading booths around the perimeter of the exchange. In total, there are approximately 3000 people who work on the trading floor, including brokers, specialists and support staff.

FIG. 1 illustrates the relationships among NYSE participants in a typical order flow. Orders are placed with a floor clerk either by NYSE members, or by non-members qualified to place direct phone business. The floor clerk directs the order either to a commission broker or to an independent ($2) broker via paper, phone or other communications means.

FIG. 2 provides a more detailed order flow for an order received from a NYSE member. As shown, the member can initiate an order by means of telephone or electronic transfer, for transfer to either a commission broker via a clerk or to an independent broker, and for execution at a specialist booth. Information about completed transactions for commission brokers is electronically recorded (for example, by NYSE's Broker Booth Support System or BBSA).

FIG. 3 illustrates a detailed order flow for an order placed by an independent broker as a “give-up” to a commisision broker. Again, information about completed transactions for commission brokers is electronically recorded.

Historically, associated billing and reporting processes for the involved parties have been largely manual, consuming substantial time and resources to perform. In order to provide a better means for auditing involved parties and ensuring process compliance, the NYSE has implemented a process that collects transactional data produced by the involved parties, and produces a daily electronic log containing this data (referred to as the “Machine Readable Output Merger Order Log”, or MOLMRO). Other electronic sources of transaction data (for example, from NIFX, SIAC and Tradeware sources) are also used to capture additional and corroborative transaction information. However, with these multiple and often inconsistent data sources and the underlying complexity of the associated transactions, transaction processing remains a difficult, time consuming and still largely manual process.

It would be advantageous to have an automated means capable of effectively using transaction data from one or more data sources to support automated billing, reporting and compliance processes.

### SUMMARY OF THE INVENTION

The present invention provides an automated rules-based transaction processing system, in particular directed to support transaction reconciliation, billing, reporting and compliance activities. This rules-based processing system operates to collect and interpret information from multiple data sources, and includes means for correcting incorrect/and or inconsistent data, for inserting missing data, for reformatting the data in a user-friendly format, and for creating associated billing invoices and other reports. A rules-based engine component of the system is used to interpret data from the multiple data sources, and to process this data according to a specific and predetermined rules governing data correction, populating missing data, formatting processed data and reporting data exceptions. A concise audit trail is created for compliance reporting and exception handling. As an outcome, for example, of exception handling, rules may be changed in or added to the rules base. In this manner, transaction processing in support of reconciliation, auditing, billing and business analyses can be performed in a largely automated fashion.

### BRIEF DESCRIPTION OF THE DRAWINGS

A more complete understanding of the invention may be obtained by reading the following description of specific illustrative embodiments of the invention in conjunction with the appended drawing in which:

FIG. 1 illustrates the relationships among NYSE participants in an order flow;

FIG. 2 provides a more detailed order flow for an order received from a NYSE member;

FIG. 3 illustrates a more detailed order flow for an order received from an independent broker;

FIG. 4 illustrates a process flow for a broker management system according to the present invention;

FIG. 5 presents a schematic diagram for the BBS system;

FIGS. 6A-6C illustrate sample NYSE MOLMRO reports;

FIGS. 7A-7D provide a data definition for each of the fields of MOLMRO REPORT 1A and REPORT 2A;

FIG. 8 presents a schematic diagram for the BBS system as contemplated by the present invention;

FIG. 9 illustrates participant relationships used to interlink data in the BBS system;

FIG. 10 illustrates the principle components of the BBS software application;

FIGS. 11A-11E illustrate basic screens provided in the user interface of the BBS system;

FIGS. 12A-12H illustrate a number of additional screens provided in the user interface of the BBS system;

FIGS. 13A-13D illustrate the invoice creation process using the user interface of the BBS system;

FIGS. 14A-14D illustrate how data is processed by the BBS system to create an invoice creation; and

FIGS. 15A-15D illustrate the BBS system process for producing a receivable summary report.

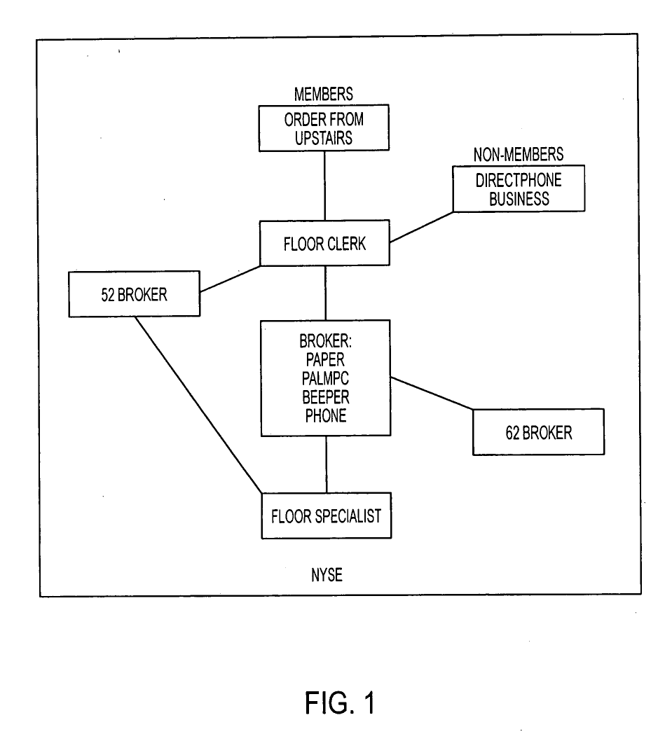

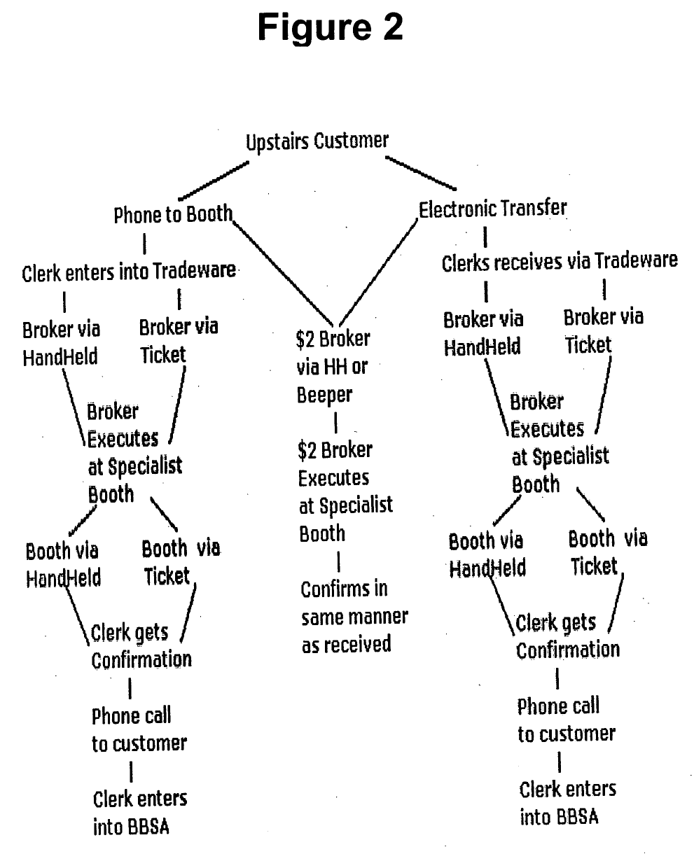

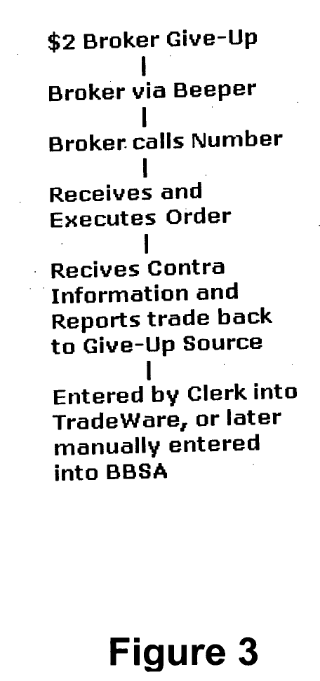

### DETAILED DESCRIPTION

The present invention is directed to a management system for managing reconciliation, auditing, billing, compliance and other business analyses for business transactions involving multiple parties and multiple information sources. For the purposes of consistency, clarity and simplicity, the description is made with reference to transaction processing at the NYSE. In addition to this disclosed application, the invention is applicable to virtually any type of transaction processing, and is particularly well-suited to transaction processing that involves multiple participants and produces multiple associated transaction processing data streams in an electronic or other easily convertible form. The present invention fully contemplates all such applications.

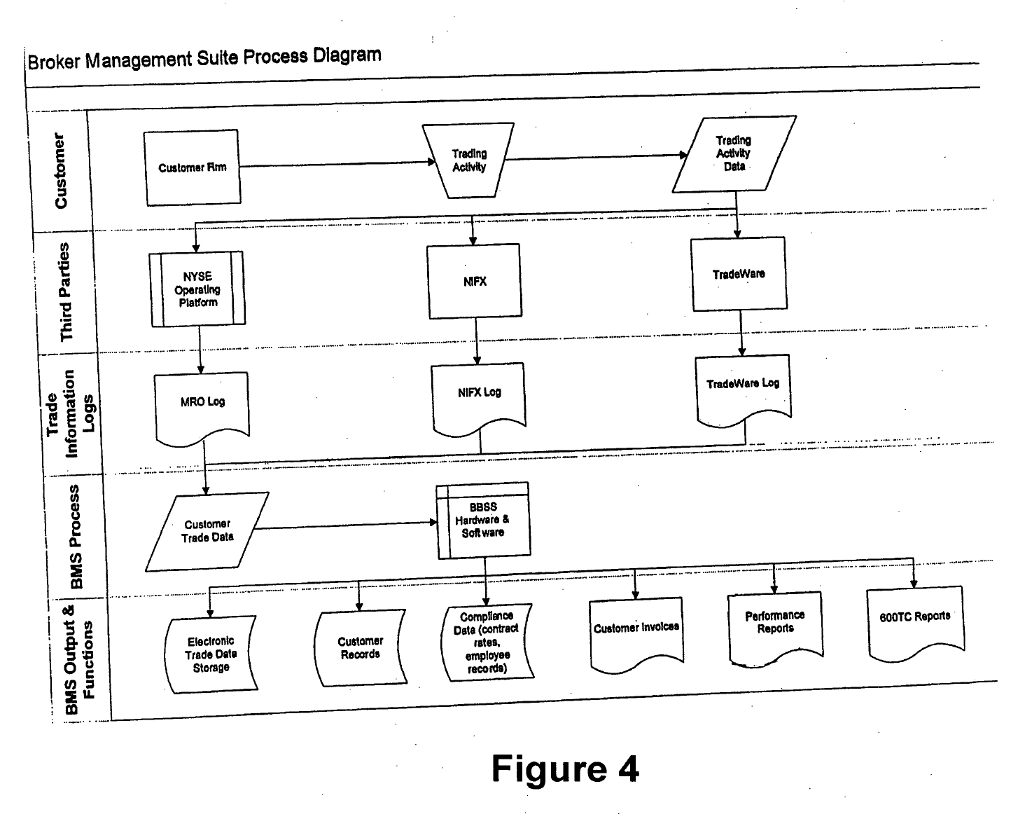

FIG. 4 illustrates a process flow for a Broker Management System (BMS) according the principles of the present invention. As shown, the BMS may be implemented as a component of NYSE's Broker Booth Support System (BBSS), or alternatively in a stand-alone computer server having a processor, memory, stored program control and communications interface for receiving data generated by various trading sources. The BMS is configured to store electronic trade data generated by these sources, customer records for individual brokers and compliance data (including, for example, contract rates and various employee records). The BMS is further configured to generate a variety of reports, including customer invoices, performance reports based on various business analysis, and compliance reports (for example, NYSE 600TC reports).

The process begins with trading activity initiated by a customer firm. Trading data is produced as a result of the activity, and is recorded in one or more forms by various third party information systems (for example, NYSE's operating platform, NIFX and Tradeware Systems). Trade information from associated information logs (for example, NYSE's MOLMRO) is periodically downloaded (for example, nightly) as customer trade data for further analysis by the BBS.

A billing function of the BBS analyzes the customer trade data to prepare customer invoices and record exceptions identified during the analysis. A manual adjustment feature allows corrections to be entered on the basis of the exception reporting. Security features including password protection enable the integrity of the information and adjustments to be protected and maintained. The BBS further preferably includes an accounts receivable function for tracking the status of invoices and customer accounts, an accounts payable function for tracking the status of payments owed by a firm, and a compliance function for producing audit data and reports (e.g., 600TC reports) to fulfill broker firm, NYSE and Securities Exchange Commission (SEC) requirements for monitoring compliance of trading activities with regard to rules, regulations and laws.

Electronically stored records may include, for example, orders for a broker's account, records relating to associated persons, customer account records, customer complaint records, participant compensation records, organization charts, employee records and the like).

A key aspect of the BBS process as described pertains to the importing, parsing and processing of the downloaded NYSE MOLMRO files. In January 2001, the NYSE decided to computerize trade data and format it so that trading organizations could receive and track their daily transactions via the MOLMRO file. The MOLMRO file consists of several thousand packets of data, send at the end of each trading day, to a specified firm. These packets contain essentially every bit of information required for processing and tracking trades. Initially, the MOLMRO file took the form of a simple file which could be manipulated using spreadsheet software such as MICROSOFT Excel. Later, the MOLMRO file format was revised to essentially pre-filter data into several different report types.

In the MOLMRO file format, eight types of reports may be transmitted, including:
1A—Order Log;
1B—Extended Log (for message use);
2A—Verified Report (with 1 contra);
2B—Verified Report (with 2 contras);
2C—Verified Report (with 3 contras);
2D—Verified Report (with 4 contras);
3A—Canceled Trade Information; and
4A—Admisitrative Information.

Only the 1A and 2 series reports, for example, are directly used for billing.

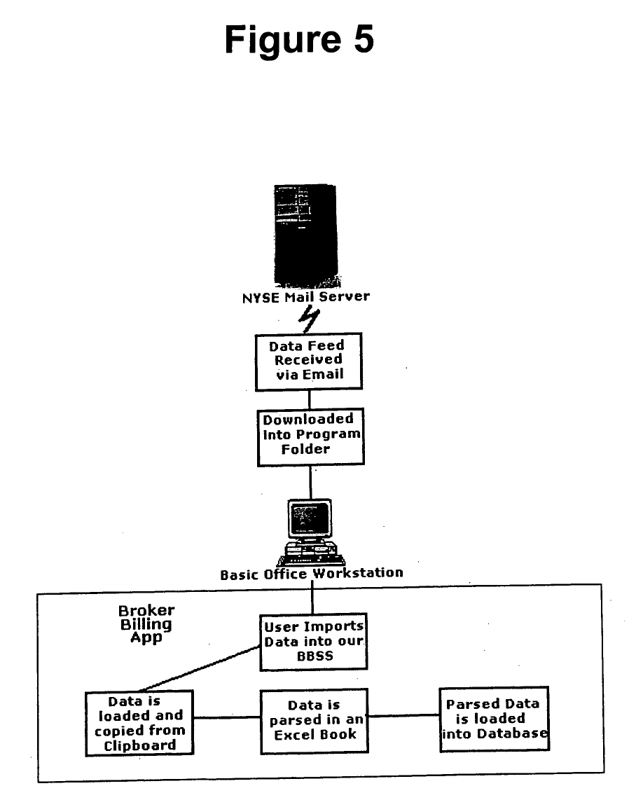

FIG. 5 presents a schematic diagram for the BBS system as contemplated by the present invention. MOLMRO data, for example, is fed by a NYSE mail server to a standard workstation via e-mail and downloaded into a program folder.

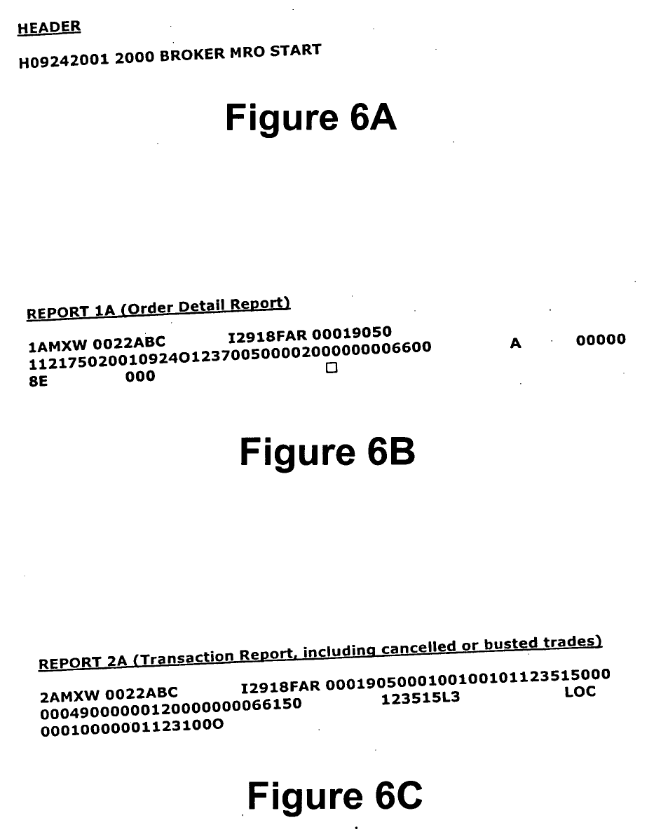

Upon receipt of the downlosded data, the BBS system operates to parse only data records beginning with a “1” or “2” (see description as to FIGS. 6A-6C below). By operation of a user (e.g., a billing broker), the MOLMRO data is imported as an instance of NYSE's BBSE, and then loaded and copied (e.g., using a “clipboard” function) to be parsed into related fields in a spreadsheet application (for example, a MICROSOFT Excel spreadsheet). The parsed fields are then combined, for example, into one “PARSED MOLMRO” datasheet that is used to populate a searchable database (“BROKER.MDB”). The database then can be quereied to populate reports and provide other requested information.

FIGS. 6A-6C illustrate sample NYSE MOLMRO reports as imported by the BBS system. In FIG. 6A, a MOLMRO header is illustrated. The header is placed at the beginning of each data transmission block, and signals the start of the data transmission. A similar string is placed at the end of the data transmission block, replacing the sub-string “START” with “END”.

FIG. 6B illustrates an Order Detail Report (“REPORT 1A”). The Report begins with a sub-string identifying the report type (“1A”). Bits 3-5 of the string (“MXW”) identify the entering firm for the trade associated with this Order Detail Report. The sub-string “0022” provides the executing broker number, and the sub-string “ABC” identifies the stock involved in the trade. The substring “FAR” identifies the customer for the trade.

FIG. 6C illustrates Transaction Report (“REPORT 2A”). This report provides either a confirmation of the order detailed in REPORT 1A, or indicates that the order has been canceled or busted. The Report begins with a sub-string identifying the report type (“2A”). As in REPORT 1A, the next sub-string identifies the entering firm (“MXW”). Following this, the next sub-string identifies the billing broker (“0022”), and the following sub-string identifies the traded stock (“ABC”).

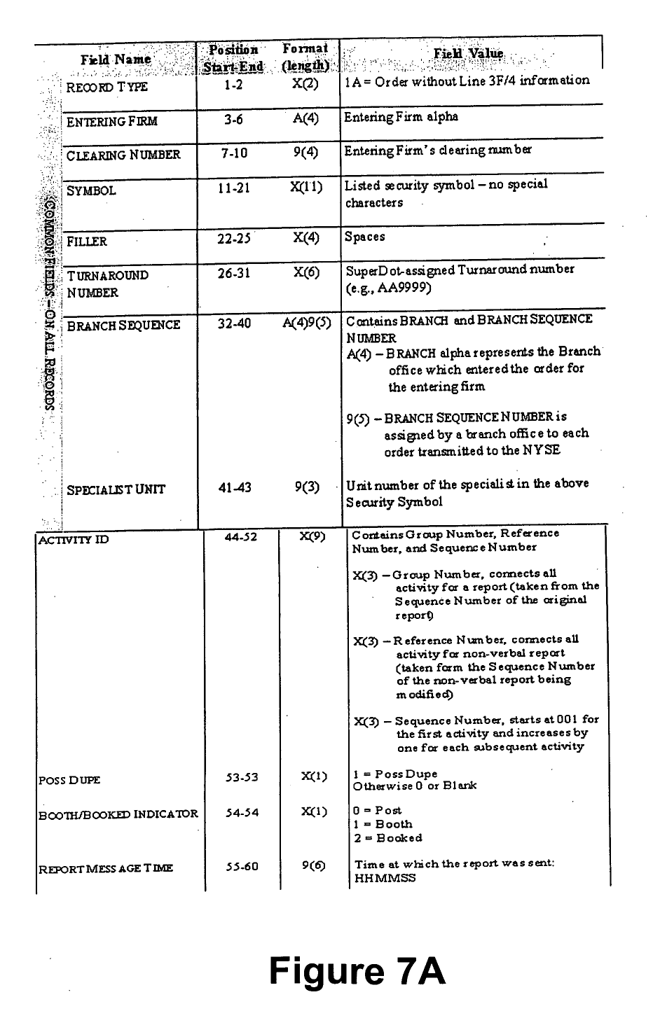

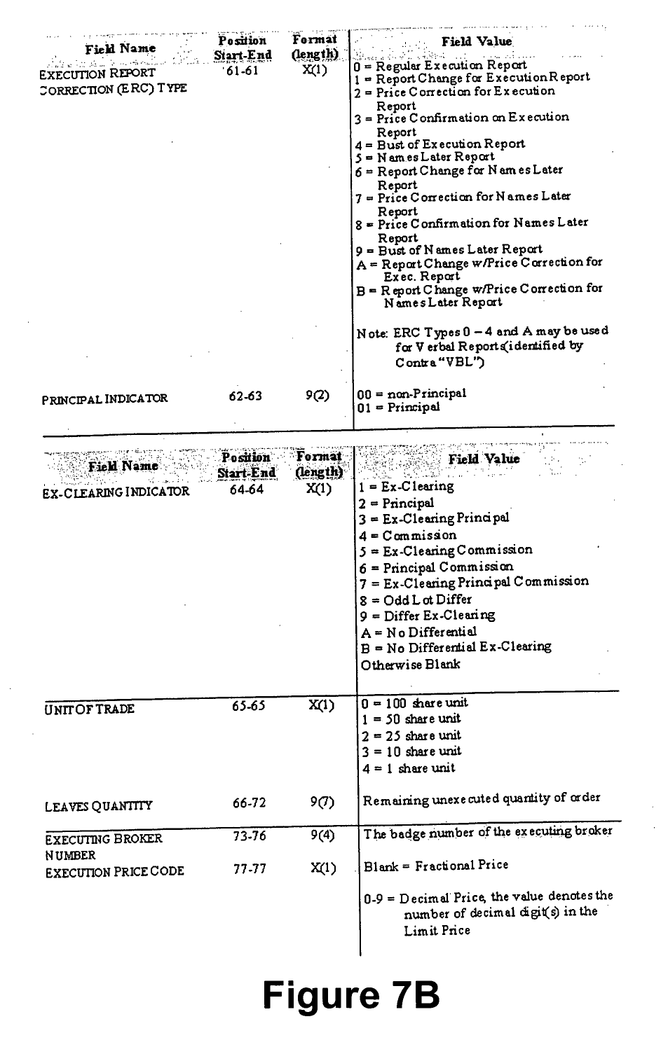

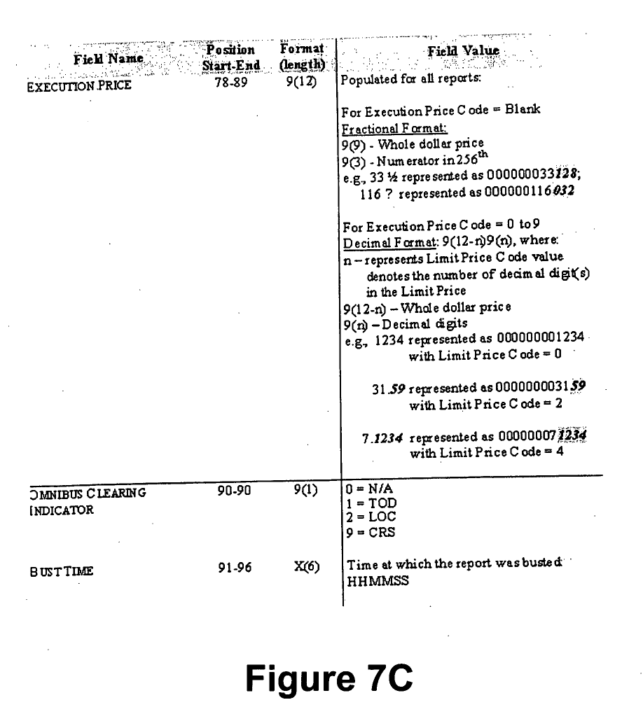

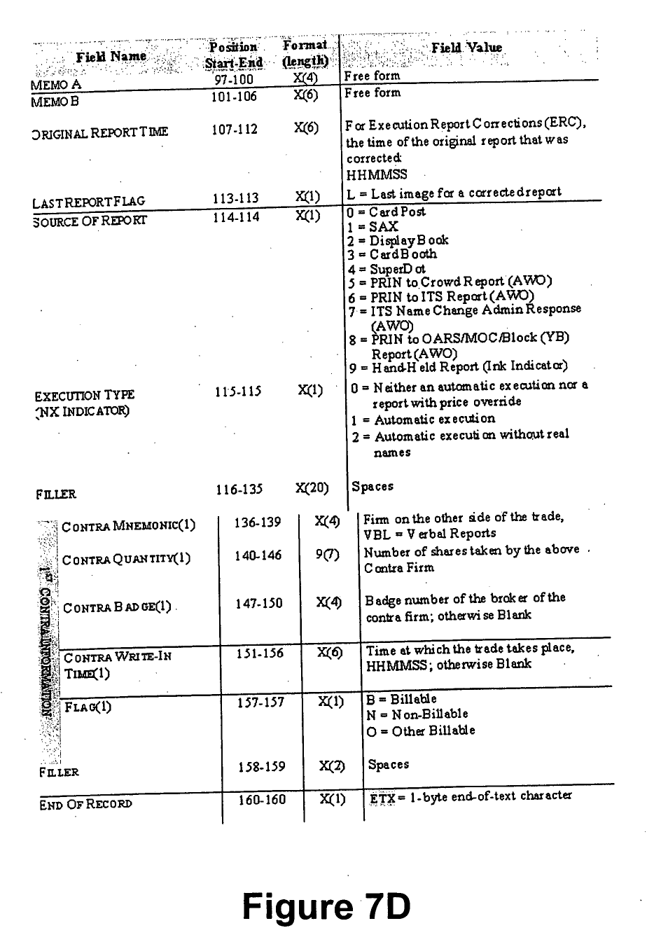

FIGS. 7A-7D provide a data definition for the each of the fields in REPORT 1A and REPORT 2A.

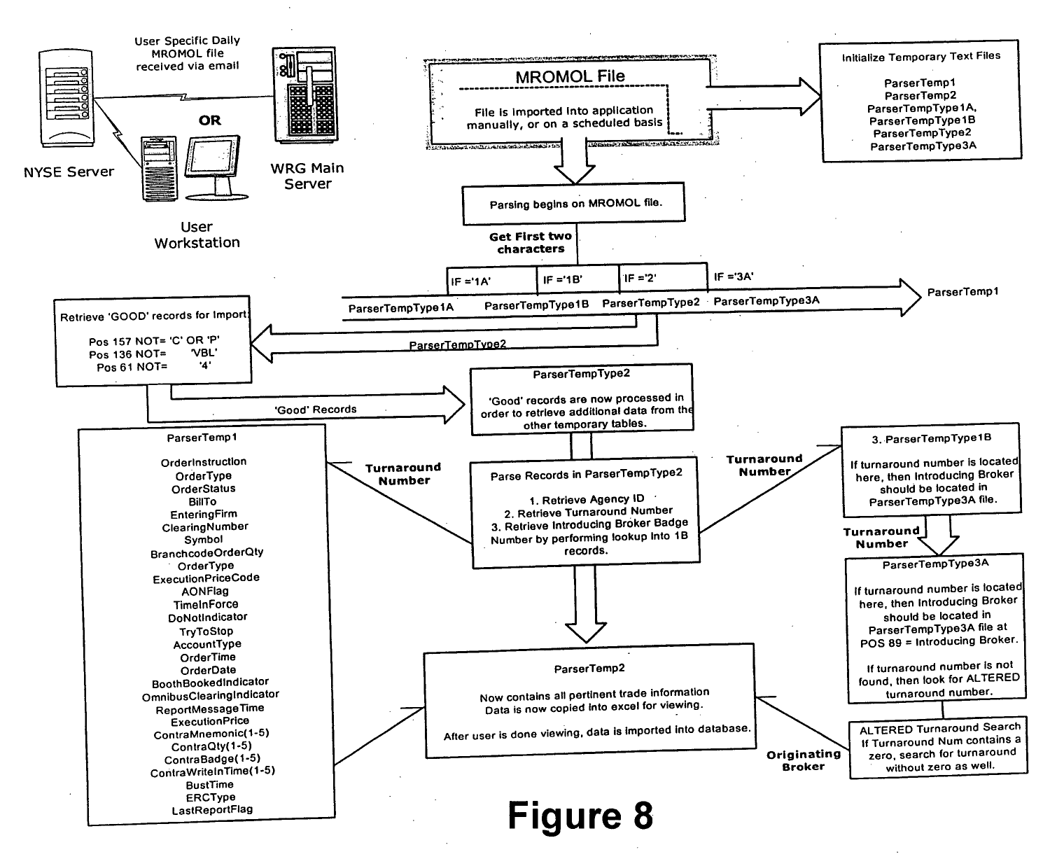

FIG. 8 provides a more detailed view of the BBS process for parsing the MOLMRO data into related fields of the spreadsheet application for combining into one “PARSED MOLMRO” datasheet that is used to populate the searchable database (“BROKER.MDB”). Each MOLMRO file includes hundreds of lines of data, representing the orders, executions and reports for all trades under a given badge number, clearing firm ID, Agency ID or specialist unit ID.

In step S1, a user elects to import the MROMOL file, and in step S2, temporary test files (“TEMP tables”) are initialized for each report type. As previously noted, valid orders are recorded only in report types 2A-2F. However, reports of types 1A, 1B and 3A also contain pertinent information that must be used by the BBS system to complete the execution information.

In step S3, type 2 records are validated and placed in a temporary file (“ParserTempType2”). Required data relating, for example, to date of transaction, purchase or sale, stock type and originating broker is acquired from related type 1A, 1B and 3A records, which are also parsed into associated temporary files (e.g., “ParserTemp1”, “ParserTemp1B”, and “ParserTemp 3A”).

A key aspect of the BBS process, in step S4, duplicated and invalid trade reports are eliminated from the ParserTempType2 file prior to populating the searchable database BROKER.MDB. This is especially importance, for example, with CAP orders, which tend to produce duplicated reports reflecting various scenarios. As illustrated in FIG. 8, several key fields (e.g., at bit positions 61, 136 and 147) may be used, for example, to identify and eliminate a duplicated record.

At step S5, the BBS process performs additional steps to properly identify an Orginating Broker and an Agency ID indicating the agency at which the order originated. The BBS process correlates the 1A, 1B and 3A type files with 2A-2F type files by means of a turnaround number (i.e., number identifying a specific trade sequence). At step S6, he BBS process looks for variations in the turnaround number (e.g., “AB123” and “AB0123”) as obvious variants referring to the same trade sequence.

At step S7, once all of the data fields have been properly populated in the type 2 files, the data is posted in the “PARSED MOLMRO” spreadsheet, and then used to populate the searchable database “BROKER.MDB”. In the spreadsheet, the data can be further adjusted and corrected by the user prior to the importing of the spreadsheet into the database.

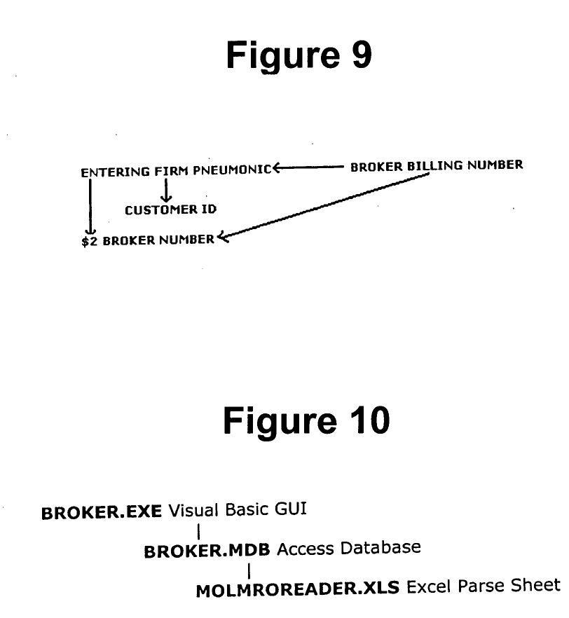

Once the data is in the BROKER.MDB database, the BBS system can be used to create and print a variety of different reports. A user has the capability to edit and delete data in real-time in the database, and also to enter data manually into the database. As illustrated in FIG. 9, a number of key relationships interlink the data records. An entering firm pneumonic is provided as a distinct identifier for a customer's billing house. Each broker is linked to an entering firm, and thereby, all of the customers of the entering firm may be linked to the broker.

FIG. 10 illustrates the principle elements of a software application component of the BBS system, implemented for example on a standard workstation as earlier described with reference to FIG. 5. The application includes a graphical user interface (BROKER.EXE) that enables the user to access and query the database (BROKER.MDB), which is populated by data received for example, from the parsed sheet (MOLMROREADER.XLS).

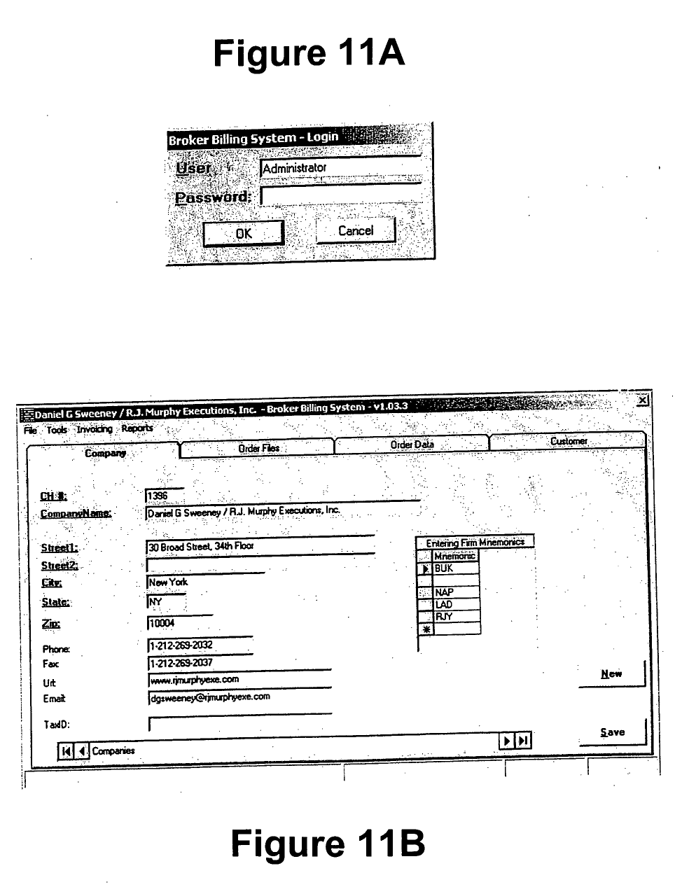

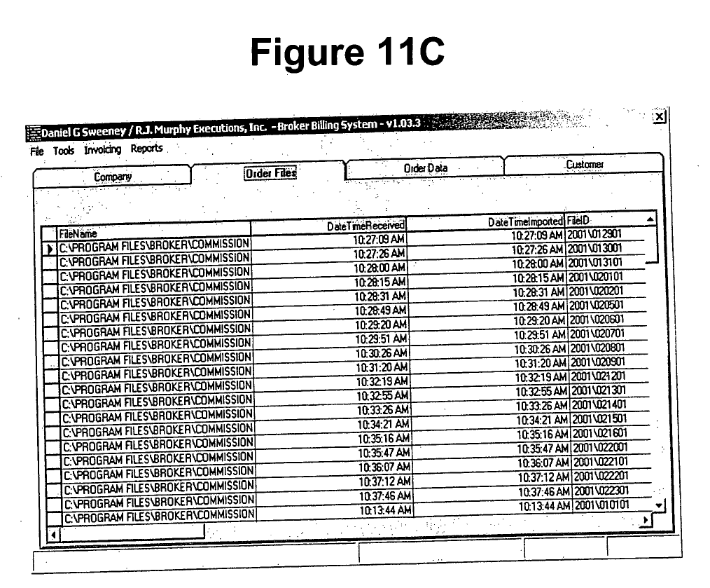

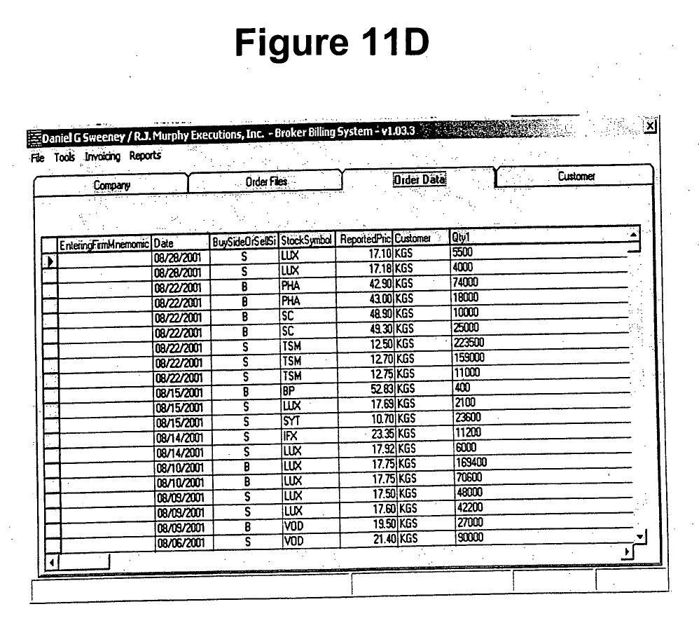

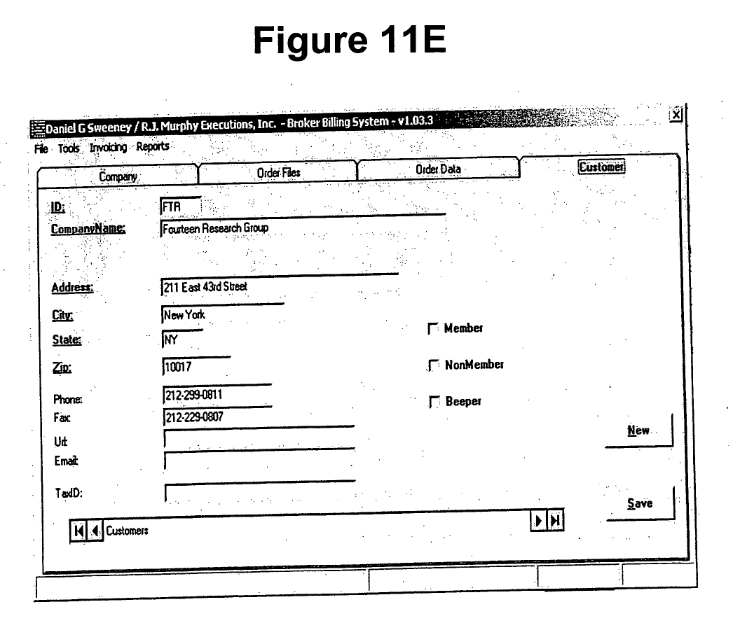

FIGS. 11A-11E illustrate sample screens that are provided to the user by BROKER.EXE for basic operations. FIG. 11A illustrates a “Login” screen that is used to protect and ensure only authorized access to the application. FIG. 11B illustrates an “Initial Company Data” tab screen that is provided for editing company information, including associations that the company has with specific customers.

FIG. 11C illustrates an “Order Files” tab screen which provides a log of all order files importer by the used into the BBS system. This screen may be used, for example, to determine what data is currently loaded and parsed into the BBS system. FIG. 11D illustrates an “Order Data” tab screen that allows editing and updating of the data represented by the order files.

FIG. 11E illustrates a “Customer Data” tab screen that is similar, for example, to the Initial Company Data screen, and allows editing of customer information in the database. The ID field, for example, presents a three-letter pneumonic that is used in the database for identifying the customer.

With reference, for example, to FIG. 11B, a number of pull-down menus (“File”, “Tools”, “Invoicing” and “Reports” tabs) are provided at the top of each screen presented to the user.

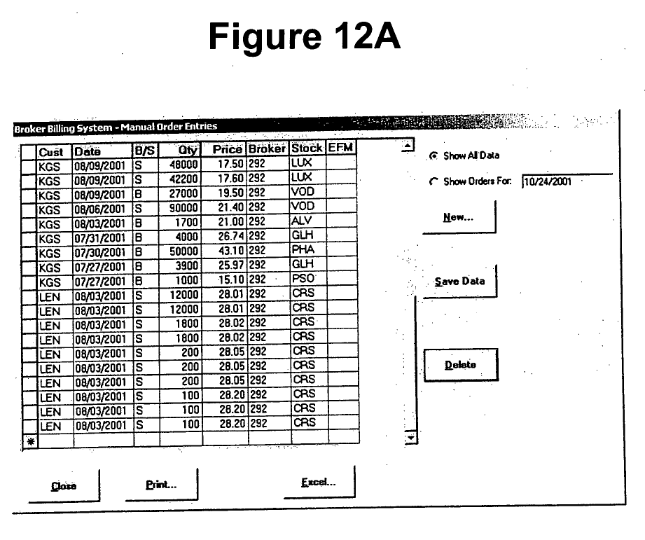

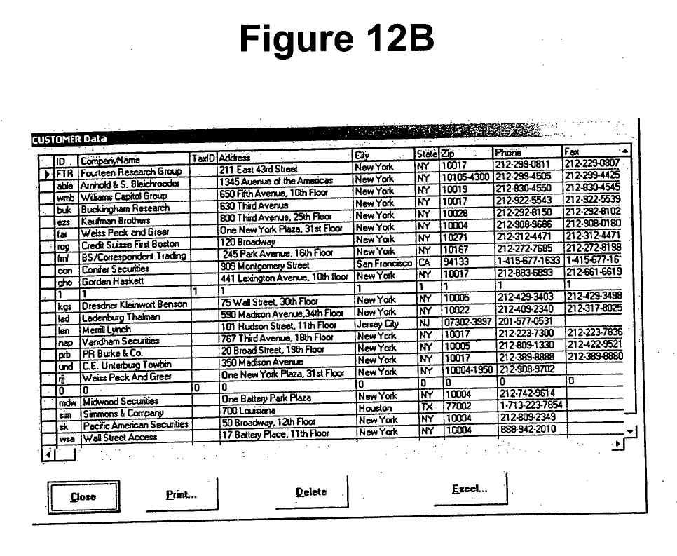

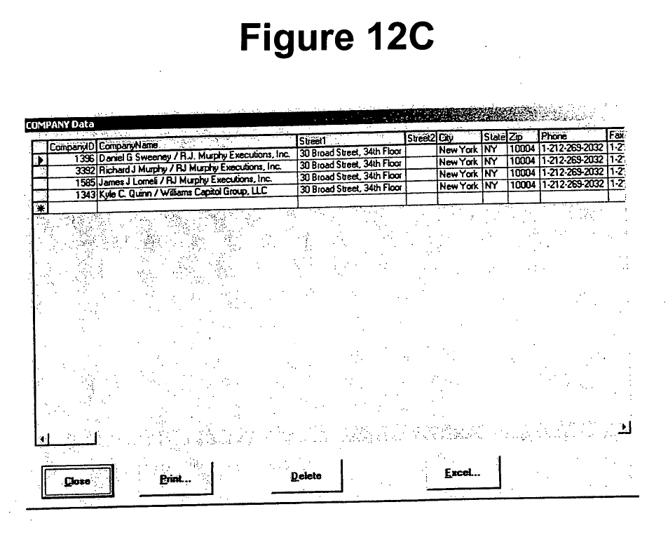

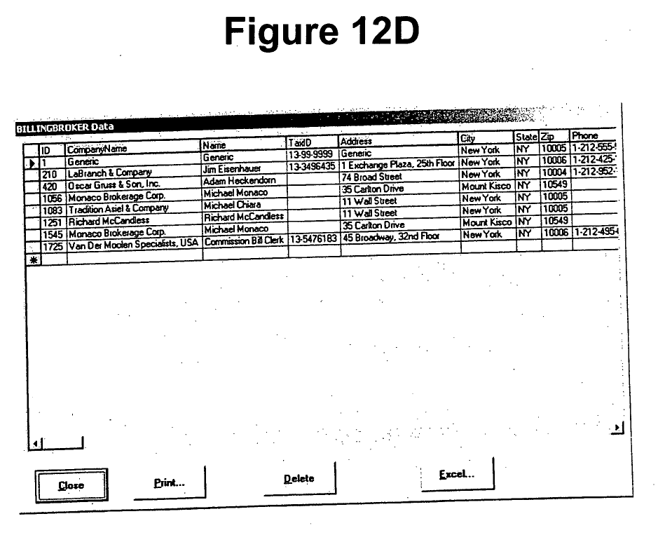

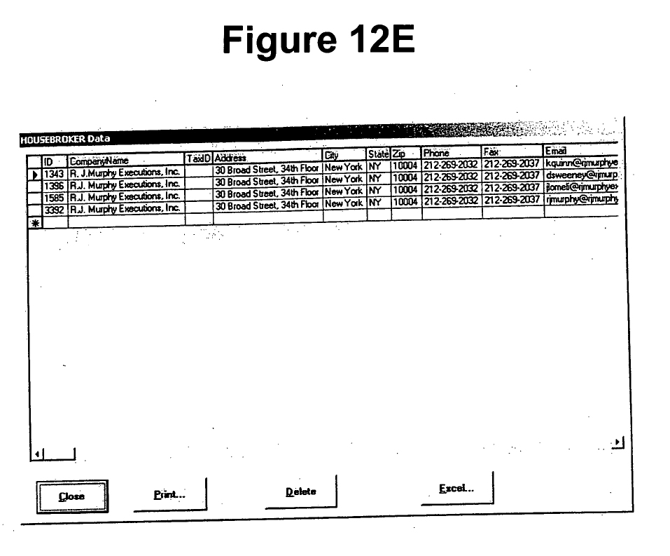

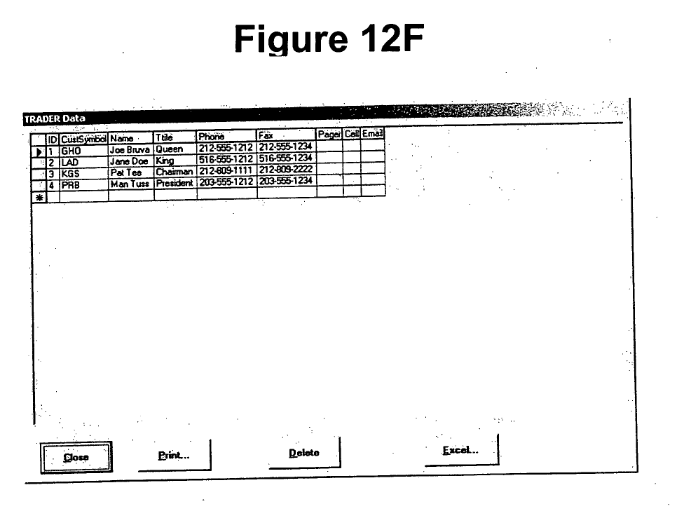

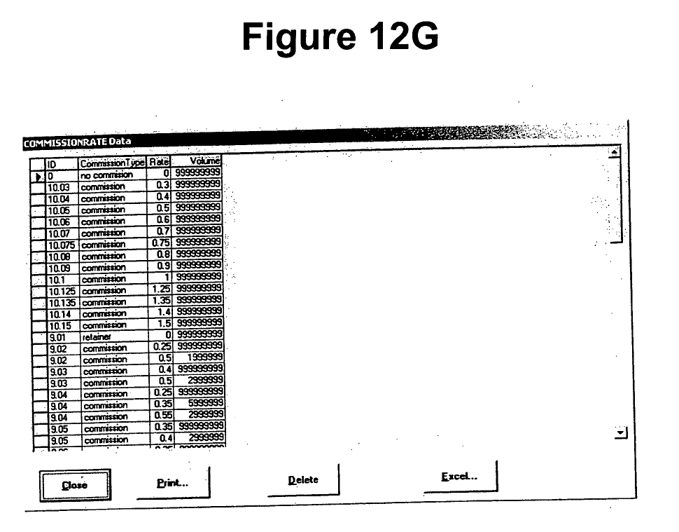

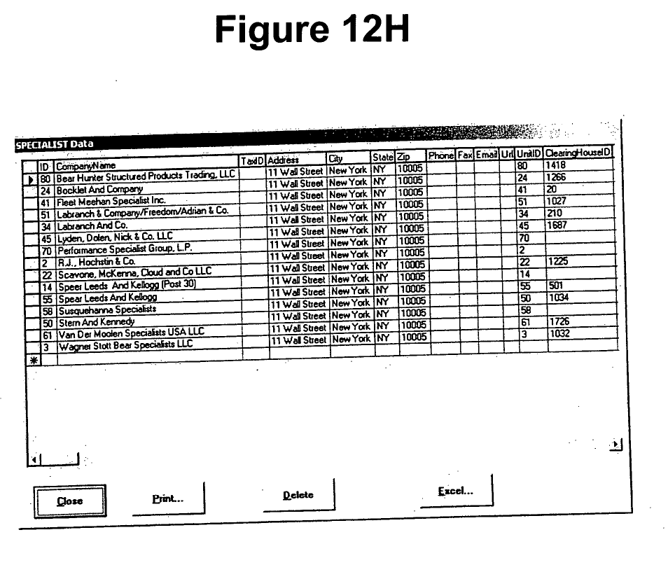

The File tab allows the user to import an MOLMRO file into the database. Once selected, the importing process may take, for example, between two and five minutes depending on the size of the incoming data feed. The File tab also allows the user to view company and customer data files and several additional tables which will be further described with reference to FIGS. 12B-12H, and to update these files as necessary.

FIGS. 12A-12H illustrate a number of additional screens that are provided to the user by BROKER.EXE. FIG. 12A illustrates a “Manual Order Entry” screen that is used for manual entries of orders that may be missing or poorly represented in the MOLMRO data. The screen prompts the user for information including company, customer, stock name, stock price and the number of shares in the trade. Buttons are provided for saving, deleting and printing the manual records, and for closing the window. Only data entered manually is presented in this screen.

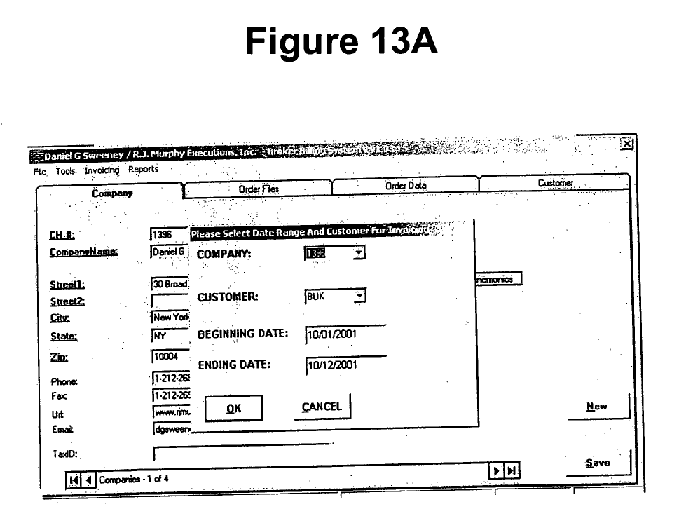

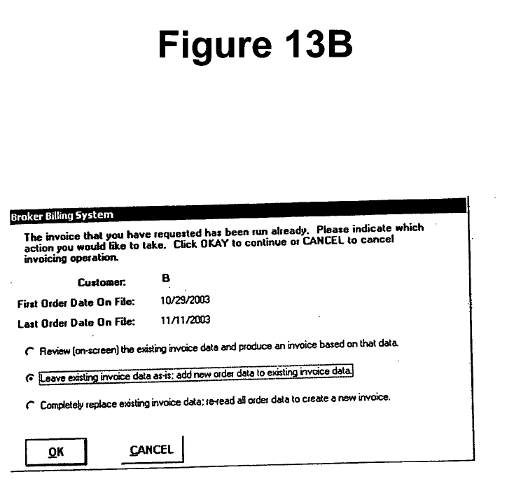

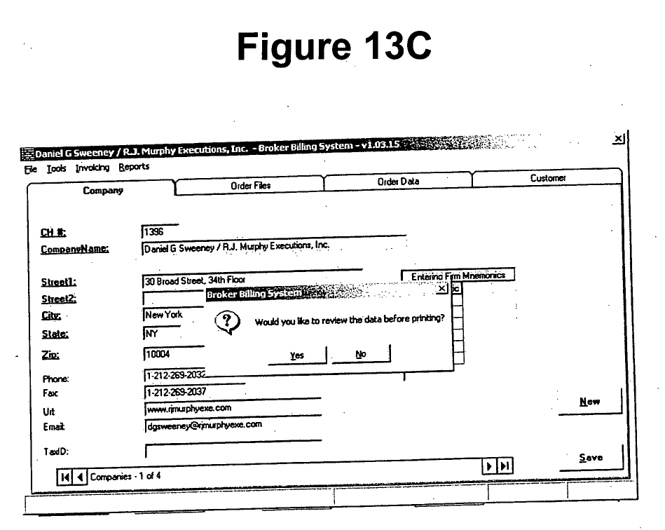

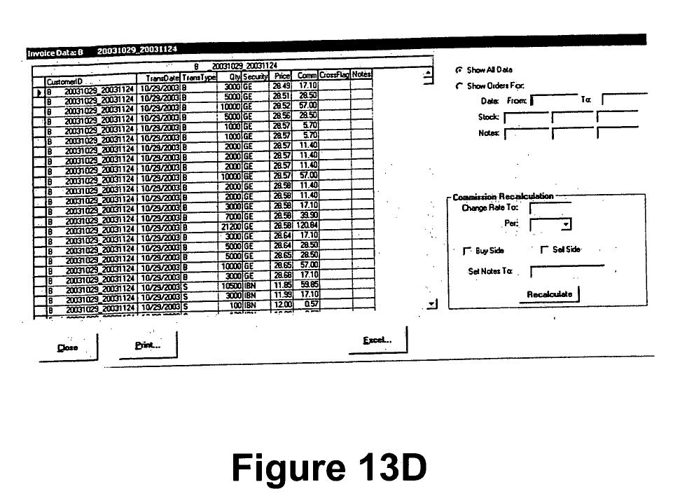

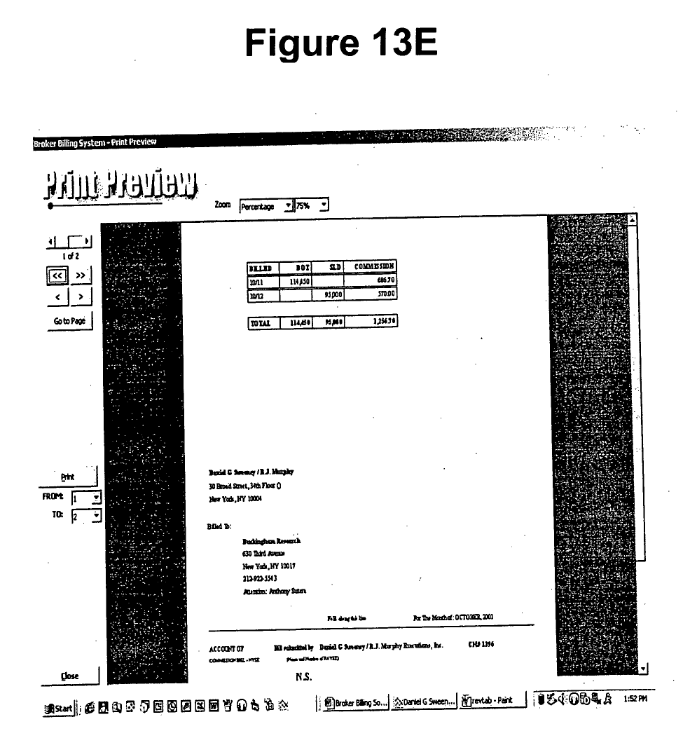

The Invoicing tab allows the user to create and edit invoices. The user is prompted to enter a number of pieces of information (for example, company, customer and date range). If an invoice has previously been created, the user will be alerted, and will be given the option either to view or re-create the invoice. The invoicing process will be discussed in greater detail with reference to FIGS. 13A-13D.

The Reports tab allows the user to create and print a variety of standard reports, including Receivables reports, Payables Reports (e.g., for trades performed by an outside source), In House Transactional Summaries (e.g., accounting for orders, executions and shares performed by in-house brokers, agencies and specialists), Billing Broker Transactional Summaries (e.g., accounting for orders, executions and shares performed by any billing broker in the system), and 600TC reports. In contrast to the invoicing process, these reports are typically generated by company rather than by company and by customer.

The Tools tab provides other functions, for example, including the Manual Order Entry screen illustrated by FIG. 12A.

FIG. 12B illustrates a “Customer Data Table” that is retrieved from the File tab. By clicking, for example, on a desired field in this table, the user is able to update associated customer data. FIG. 12C illustrates a “Company Data Table”, which is similarly retrieved from the File tab and similarly used by the user. Other tables available from the File tab for reviewing and updating data include a “Billing Broker Table” (FIG. 12D) for independent broker information, a “House Broker Data Table” (FIG. 12E) for commission of company broker information, a “Trader Data Table” (FIG. 12F), a “Commission Rate Data Table” (FIG. 12G), and a “Specialist Data Table” (FIG. 12H) for floor specialists. The House Broker Data Table is essentially a duplicate of the Company Table. Each of the trade participants identified in these tables is assigned a unique ID.

The Commission Rate Data Table of FIG. 12G allows the user to create desired commission rate IDs for the brokers and specialists. Each commission rate must have a unique ID, unless it is a varying rate. In the latter case, a single ID is used and the rate is reset as required (for example, at a discounted rate following the completion of a set volume of transactions for a particular customer in a predetermined time frame).

FIGS. 13A-13D illustrate the invoice creation process using the Invoices tab. FIG. 13A illustrates an “Invoicing” screen in an invoice field entry module of BROKER.EXE. To begin the process, the user defines the company, customer and time period for invoicing, and selects “OK” to proceed. As illustrated by FIG. 13B, in response, a subsequent screen is provided that indicates that an invoice for this company, customer and time period was previously run, and asks the user whether to review the existing data, to leave the invoice as is or to replace the existing data.

As illustrated in FIG. 13C, if no previous invoice was created, a screen is provided that asks whether the user wishes to review the resulting invoice data before printing the requested invoice. If the user selects the “Yes” button, the “Data Preview” screen of FIG. 13D is presented to allow the user to review and perform edits as required. All edited information that is entered is returned to the BROKER.MDB database. The user then is able to proceed to print the associated invoice, for example, as illustrated in FIG. 13E.

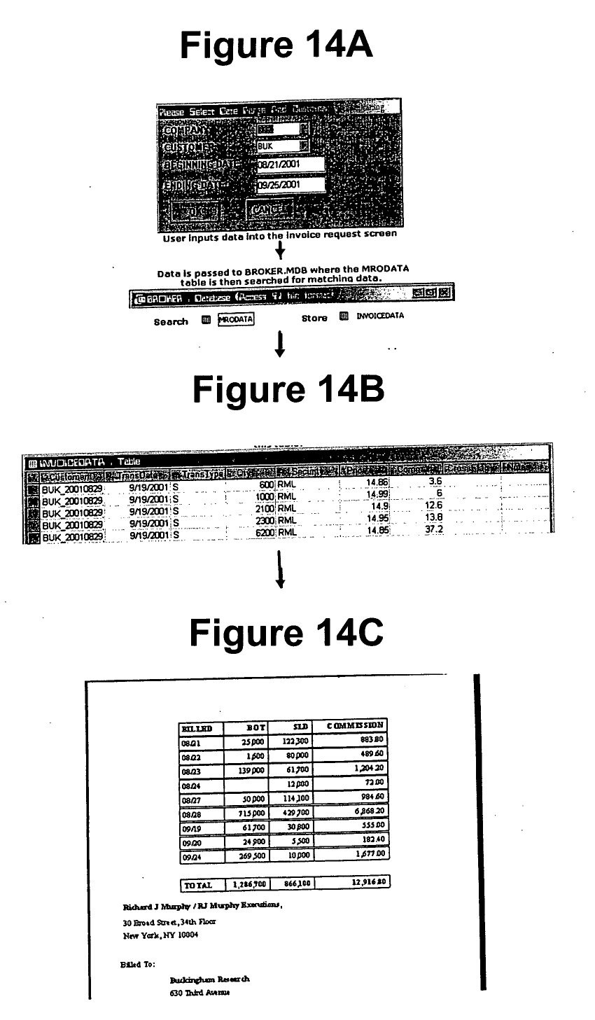

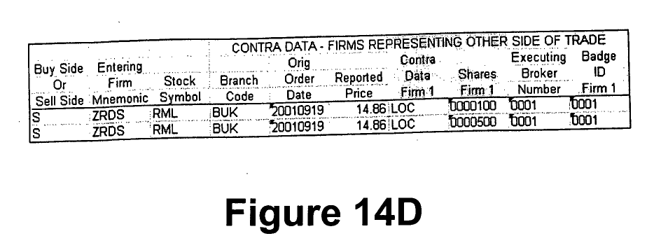

FIGS. 14A-14D illustrate how data is processed by the BBS system in response to an invoice creation request. The user inputs data into the Invoice Request screen of FIG. 14A, and the input data is saved and passed to BROKER.MDB. A search for matching data is performed in BROKER.MDB, and the results of the search are placed in the “Invoicedata” table of FIG. 14B. Further processing is performed to produce an associated invoice in a pre-designed form as illustrated in FIG. 14C.

With reference to the first row of data presented in the Invoicedata table of FIG. 14B, the first column identifies an “Invoice ID” that is created when the user requests an invoice. The data in BROKER.MDB is searched for a matching customer and date, and if the date is in range, the data is populated in the Invoicedata table.

The populated data includes a “Transaction Type” (e.g., “S” represents a sale), the number of shares involved, the associated stock symbol, the transaction price, and the resulting commission from the transaction.

FIG. 14D illustrates associated date provided in the parsed data file MOLMROREADER.XLS of FIG. 10 before the data is transferred to the BROKER.MDB database. The illustration is a shortened example omitting many data columns present in MOLMROREADER.XLS for simplicity.

As illsutrated in FIG. 14D, the transaction of 600 shares indicated in first row of data presented in the Invoicedata table of FIG. 14B was actually carried out in two blocks: one for 100 shares, and the other for 500 shares. Processing by the invoice query caused the two transactions to be grouped together for invoicing purpoese.

MOLMROREADER.XLS is populated automatically when a user imports a MOLMRO data file, according to formulas preprogrammed into the cells of the worksheet. Imported data is parsed from sheet to sheet in the spreadsheet until it finally “settles” into the “Parsed” worksheet that provides the processed MOLMRO data. This parsing reflects the following:
Only transaction data found in REPORT 2A is valid, since this report provides data for valid trades.
REPORT 1A includes valuable data, but not all of the data is useful. For example, some of the data represents orders that have not been carried out, and may never be carried out.
Each valid transaction in a REPORT 2A is spawned from an order in a REPORT 1A. The key then becomes matching the appropriate two reports.

Thus, for example, as an embodiment of the rules-based transaction processing element contemplated by the present invention, formulas are used to check that data in a REPORT 1A sheet correctly matches data in a corresponding REPORT 2A sheet. For example, the following formula may be used to determine the transaction type of a particular trade:
IF(IF(AND(MID(‘Raw MOL−MRO Data’!$A1,1,1)=“2”,MID(‘Raw MOL−MRO Data’!A1,136,4)⋄“VBL”), VLOOKUP (06,‘1Alookups’!$A$1:$0$5000,6,FALSE),“”)+“1”, “B”,“S”) [1]

This formula performs the following:
1) If the first bit of the data is equal to “2” (defining a “2A” report),
2) And the report is not of type “VBL” (pertaining to a verbal, and therefore not a valid report),
3) Then look up the distinct “Turn Around Number” (an ID given to a specific trade genuine to that transaction only) in the “1A” sheet,
4) And find the matching “TA Number”.
5) Once this is found, find if the order is for a “Buy” or a “Sell”, and place that information in the associated column.

Other formulas are similarly used to validate and populate the other cells of the table.

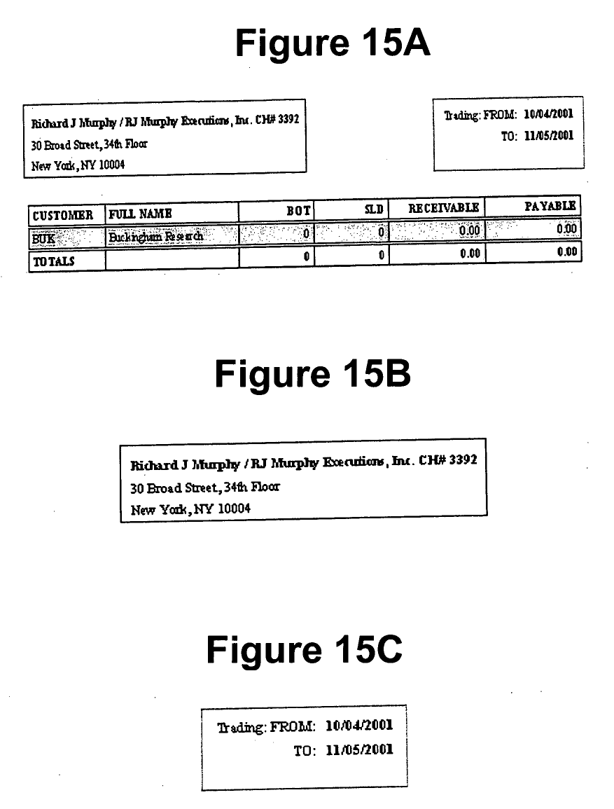

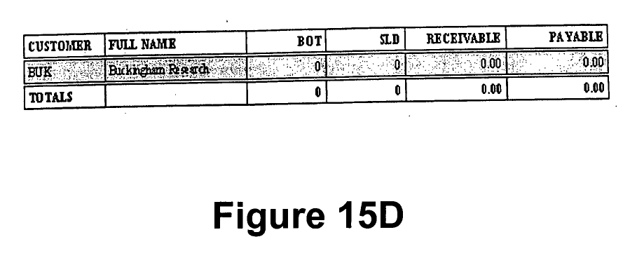

FIGS. 15A-15D illustrate the BBS system process for producing a receivable summary report. FIG. 15A illustrates a “Receivable Summary” report shell. One component of the shell is the billing company information section (FIG. 15B), which is populated form the BROKER.MDB database based on a user-provided customer number (3392). Another component of the shell is the trading date section (FIG. 15C), which includes additional date information entered by the user.

The receivable summary section of the shell (FIG. 15D) is produced by searching the Invoicedata Table of FIG. 14B against the customer and trading date information provided by the user. Accordingly, the Invoicedata Table must be created and verified before the Receivable Summary Report is produced.

The foregoing describes the invention in terms of embodiments foreseen by the inventor for which an enabling description was available, notwithstanding that insubstantial modifications of the invention, not presently foreseen, may nonetheless represent equivalents thereto.

1. A method for preparing a valid data record based on a data record of a first type and a data record of a second type, the method comprising the steps of:
receiving a data stream including said data record of said first type and said data record of said second type;
parsing the data stream into said data record of said first type and said data record of said second type;
analyzing a first field of said data record of said first type to determine that said data record of said first type is valid;
storing said valid data record of said first type in a first temporary data file;
storing said data record of said second type in a second temporary data file;
comparing data stored in a second field of said data record of said first type with data stored in said data record of said second type to determine that said data record of said second type and said data record of said first type are related;
identifying data required for said valid data record that is provided in a third field of data record of said second type;
analyzing data in said third field of said data record of said second type to determine that said third field of said data record of said second type contains valid data;
preparing said valid data record based on said data record of said first type and said valid data in said third field of said data record of said second type; and
storing said valid data record in a third data file.

2. The method of claim 1, comprising the additional step of:
analyzing a fourth field of said data record of said first type to determine that said fourth field of said data record of said first type contains valid data, wherein said analyzing step includes comparing data in said fourth field of said data record of said first type with data of said data record of said second type.

3. The method of claim 1, wherein said determination that said third field of said data record of said second type contains valid data is made by applying a predetermined rule to data stored in said third field of said data record of said second type.

4. The method of claim 3, wherein said determination is made by applying said predetermined rule to data stored in said third field of said data record of said second type and to data stored in at least one additional field in one of said data record of said first type and said data record of said second type.

5. The method of claim 1, wherein said data record of said first type and said data record of said second type each include data associated with one or more sales transactions.

6. The method of claim 5, wherein the sales transactions are directed to sales of securities.

7. A system for preparing a valid data record based on at a data record of a first type and a data record of a second type, the system comprising:
an input device for receiving a data stream including said data record of said first type and said data record of said second type;
a memory;
a processor having a stored program control, said processor communicating with the input device and the memory to carry out the steps of:
parsing the data stream into said data record of said first type and said data record of said second type,
analyzing a first field of said data record of said first type to determine that said data record of said first type is valid,
storing said valid data record of said first type in a first temporary data file of said memory,
storing said data record of said second type in a second temporary data file of said memory,
comparing data stored in a second field of said data record of said first type with data stored in said data record of said second type to determine that said data record of said second type and said data record of said first type are related,
identifying data required for said valid data record that is provided in a third field of data record of said second type,
analyzing data in said third field of said data record of said second type to determine that said third field of said data record of said second type contains valid data,
preparing said valid data record based on said data record of said first type and said valid data in said third field of said data record of said second type, and
storing said valid data record in a third data file of said memory.

8. The system of claim 7, further comprising:
a database residing in said memory and being operative under instruction of said processor to receive and store data from said third data file.
a user interface including a display, wherein said user interface is operative to query said database to retrieve data stored in said database from said third file, and to format and display said retrieved data on said display.

9. The method of claim 7, wherein said data record of said first type and said data record of said second type each include data associated with one or more sales transactions.

10. The method of claim 9, wherein the sales transactions are directed to sales of securities.
